(19) United States
(12) Patent Application Publication
(10) Pub. No.: US 2010/0219956 A1
(43) Pub. Date: Sep. 2, 2010

(54) Heat Sensor Device and System

(76) Inventors: Eugene Greco, Mt. Arlington, NJ (US); Marisol Castellanos, Randolph, NJ (US)

Correspondence Address: BENJAMIN APPELBAUM, PH.D.;ATTORNEY AT LAW, 27 BENNINGTON DRIVE, FLANDERS, NJ, 07836, US

(21) Appl. No.: 12/086,986

(22) PCT Filed: Nov. 20, 2007
(86) PCT No.: PCT/US2007/024243

§ 371 Date: Jun. 23, 2008

Related U.S. Application Data
(60) Provisional application No. 60/945,412, filed on Jun. 21, 2007.

(51) Int. Cl. G08B 17/00

(52) U.S. Cl. 340/586

(57) ABSTRACT

A device for detecting the heat of an area, such as a door within a burning structure, can be attached to garments worn by a firefighter or rescue personnel. The device includes a temperature probe through which light emitted by the target area enters, striking a temperature sensor which is in electronic communication with a microprocessor, an alarm circuit, and a visual display. If the detected temperature exceeds a specified threshold, the alarm goes off, warning the user of a potentially dangerous situation. By wearing a device either attached to a helmet, sleeve of a jacket, or boot, the user can readily detect the temperature, without adversely affecting their ability to carry equipment necessary to deal with an emergency situation.

### CROSS-REFERENCES TO RELATED APPLICATION

This application claims the benefit of U.S. Provisional Application Ser. No. 60/945,412, filed 21 Jun. 2007, the contents of which are hereby incorporated by reference herein in their entirety.

### FIELD OF THE INVENTION

The present invention is a device and system for detecting hot areas within a structure, such as a building, which is burning or in which a fire or smoke-condition may exist. When the heat sensor component detects a temperature that exceeds a specified threshold, an audible alarm sounds, thus warning the user, such as a firefighter or other emergency personnel, such as police, rescue squads, emergency medical technicians, and the like, of such heat, enabling them to take additional precautions because of the presence of a potentially dangerous condition. In an embodiment of the system, the heat sensor is attached to an article of clothing worn by the user.

### BACKGROUND OF THE INVENTION

One of the problems encountered by firefighters and other rescue personnel is knowing how hot an area or part of a structure they may be entering is. In the environment of a burning structure, visibility is often obscured by flames and smoke. In addition, noise from sirens, the fire itself, and other factors can affect the firemen's hearing, potentially adversely affecting a fireman's senses.

Prior to entering a closed portion of the structure, such as another room, a fireman would like to know how hot the area is, and this is most commonly done by feeling the outside surface of a door or other barricade. The relative degree of heat felt by the firefighter (through their protective gloves), in combination with that firefighter's experience, provides a qualitative estimate of how hot the area might be, but such estimates can vary from one person to the next, based on the skill and experience of different firefighters. Other times the firefighter may use their feet in a similar manner, to have an approximation about the heat of the floor. Knowing how hot the floor underneath them is also important, because this can help prevent being caught in a cave-in or collapse of the floor from damage beneath the floor. Thus there is a need for a device that not only could be used to detect the heat of an area within a structure, but can provide its user with an audible warning that the temperature of such a particular region is at or above a specified level.

By mounting one or more heat sensor devices on their clothing, a firefighter so equipped can be able to determine the heat of an area, such as the floor, a wall, or higher area, such as that around their head, during the course of their work, and thus, be able to take appropriate precautions when a warning is emitted.

### BRIEF SUMMARY OF THE INVENTION

It is an object of the present invention to provide a device that can be used to detect “hot” areas within an enclosure in which a fire or smoke condition may exist, a “hot” area being an area having a temperature in excess of a specified threshold.

Another object of the present invention to provide a system that can be used to detect “hot” areas within an enclosure in which a fire or smoke condition may exist.

Another object of the present invention to provide a system that can be worn on the person of a firefighter or other emergency personnel, and warn them of “hot” areas within an enclosure in which a fire or smoke condition may exist.

Still another object of the present invention is to provide a system that can be attached to the clothing of a firefighter or other emergency personnel, and warn them of “hot” areas within an enclosure in which a fire or smoke condition may exist.

Still another object of the present invention to provide a system to detect hot areas within an enclosure in which a fire or smoke condition may exist, that is economical to manufacture, and durable in construction.

Thus, embodiments of the present invention include a device for detecting the heat of an area, such as a door within a burning structure, that can be attached to garments worn by a firefighter or rescue personnel. The device includes a temperature probe through which light emitted by the target area enters, striking a temperature sensor which is in electronic communication with a microprocessor, an alarm circuit, and a visual display. If the detected temperature exceeds a specified threshold, the alarm goes off, warning the user of a potentially dangerous situation. The device includes both an audible alarm, and a visual alarm. By wearing a device either attached to a helmet, sleeve of a jacket, or boot, the user can readily detect the temperature, without adversely affecting their ability to carry equipment necessary to deal with an emergency situation.

### BRIEF DESCRIPTION OF THE SEVERAL VIEWS OF THE DRAWING

FIG. 1 is a plan view of an exemplary heat detector used in conjunction with the present invention.

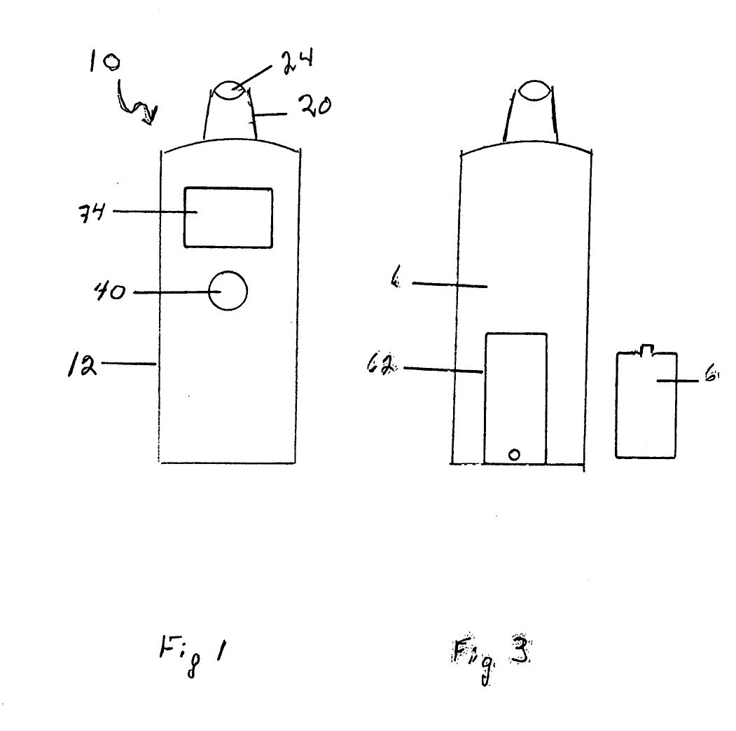

FIGS. 2A-C are side views illustrating how the detector of the present invention may be worn, attached to a helmet (FIG. 2A), a boot (FIG. 2B) and a sleeve of a coat or jacket (FIG. 2C).

FIG. 3 is a bottom view of the embodiment shown in FIG. 1.

FIG. 4 is a sectional view of the probe illustrated in FIG. 1.

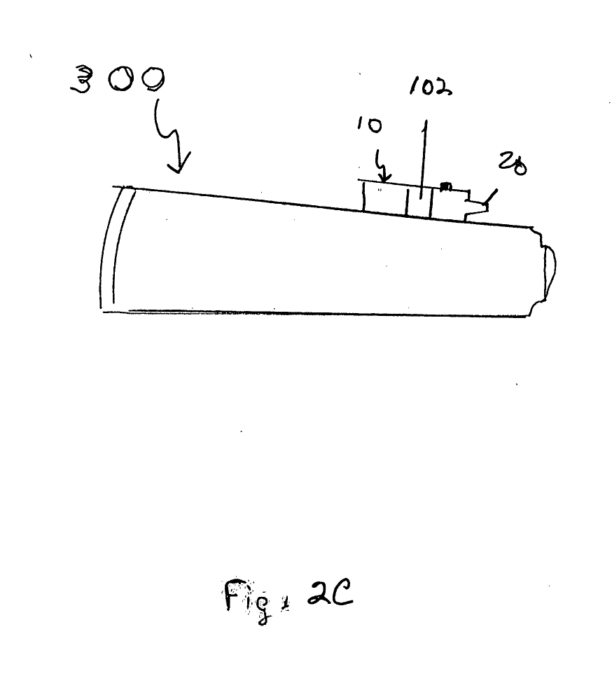

FIG. 5 is a sectional view of a protective covering for the probe.

FIG. 6 a schematic illustration of the circuitry of the embodiment shown in FIG. 1.

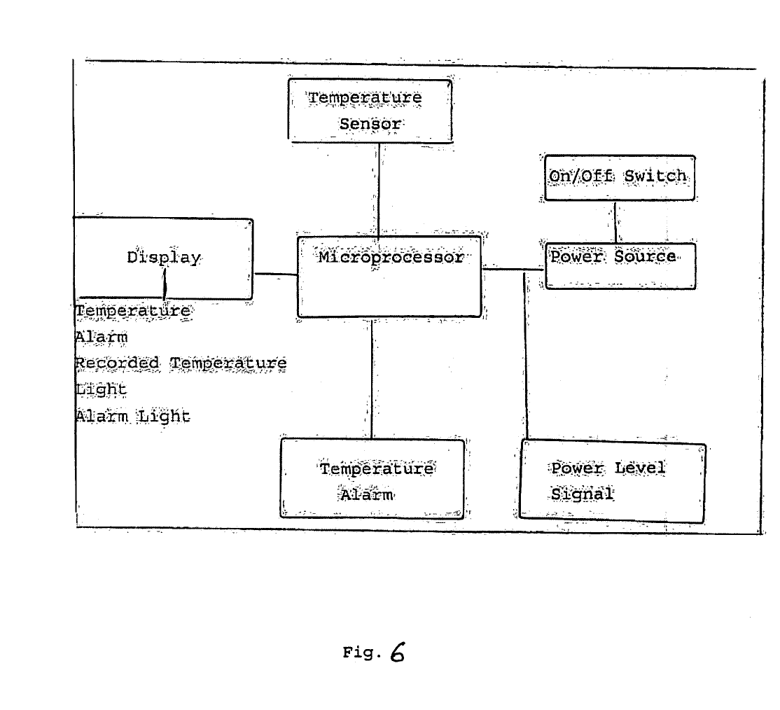

### DETAILED DESCRIPTION OF THE INVENTION

One of the inventors is a former volunteer firefighter, and has dealt with many conditions where one cannot always know how hot a particular region of a burning building is before entering that particular region.

Depending upon the location, for example, if the floor is hot, there is the chance for it to collapse, such as from damage to the supporting structure. If the ceiling is hot, there is similar danger of a collapse, only from above rather than from below. If the wall or door is hot, there is the chance of entering an area with a raging blaze, or an area with the potential for a dangerous backdraft to occur, all of which require cautionary action on the part of the firefighter.

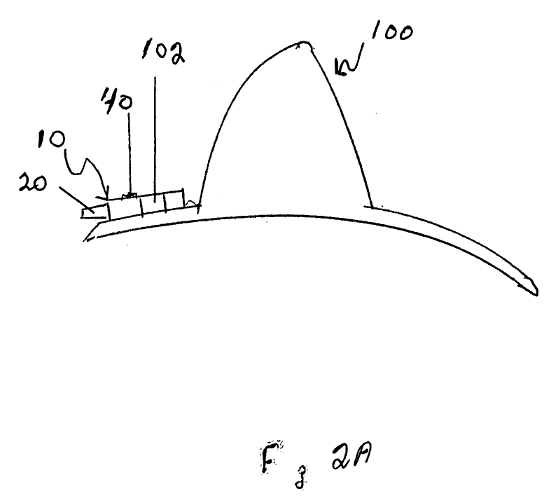

An embodiment of the present invention is a heat detector 10 which is attached to the clothing of the firefighter. The article of clothing may be a helmet 100, a boot 200, or a sleeve 300 of a coat or jacket (FIG. 2), the articles of clothing most commonly used by firefighters, and also the ones most likely to be in some proximity and/or contact with the structure. However, the application of embodiments of the present invention is not intended to be limited only to those articles of clothing illustrated herein, but could also be attached to other articles of clothing worn by fire or rescue personnel, such as pants, belts, shirts, suspenders and the like. In the alternative, the heat detector 10 could be handheld and used by itself, but by attaching it to an article of clothing leaves the firefighter's hands free to carry the necessary firefighting equipment, rescue gear or the like.

Referring to the figures, detector 10 comprises a body 12, a temperature probe 20 which is in communication with a temperature sensor 30, on-off switch 40, an audible alert mechanism 50, a power source 60 and appropriate circuitry 70.

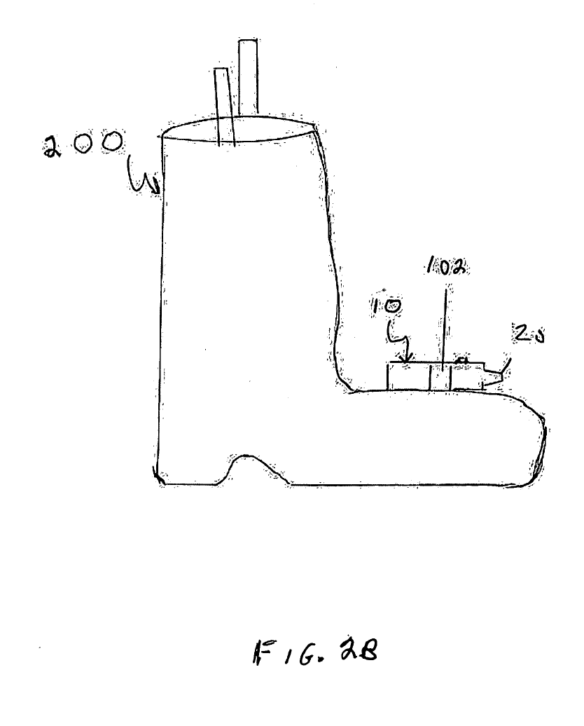

The temperature probe 20 is connected to the body 12, and the probe includes a wall 22 containing an opening 24 through which light, such as the infrared light being emitted by the target (that is, a wall, door, floor, ceiling, fire, etc.) can pass and strike the temperature sensor mechanism 30. The opening 24 is closed off from the external environment by a window 26, which is transparent to the particular wavelength(s) of light being used to measure the temperature of the target. The location of the window 26 is not critical; it can be at the inner end of the opening 24, proximate where the probe 20 joins the body 12 (FIG. 3) or it can be towards the outer end of the opening 24 (not shown).

To protect the probe from becoming contaminated by smoke, cinders, or other debris encountered during the course of business, an additional protective covering 90 can be attached over the probe 20, such as by means of a press-fit or thread, and be removed and replaced should debris accumulate thereon and adversely affect the performance of the device 10. The protective covering can be made of a material similar to that of the probe 20, and the window 92 contained therein be manufactured can be a plastic material that is compatible with the window 26, allowing the appropriate wavelength of light to enter the probe 20.

Additional coverings 90 could be packaged as part of a kit that would be carried by the user, such a kit containing a plurality of additional coverings 90, and spare batteries 60.

The circuitry can be programmed at the factory so that the audible alert mechanism will be activated when the temperature detected is above a certain threshold. The threshold can be specified by a particular fire department, or using the recommendations of either a national or local fire code. The audible alert mechanism has to be capable of emitting at least 80 decibels in order for it to be heard.

The temperature threshold for the audible warning mechanism 50 can be set for temperatures of, for example, 300 degrees F. (148.9 degrees C.), 500 degrees F. (260 degrees C.), 1000 degrees F. (538 degrees C.), or higher.

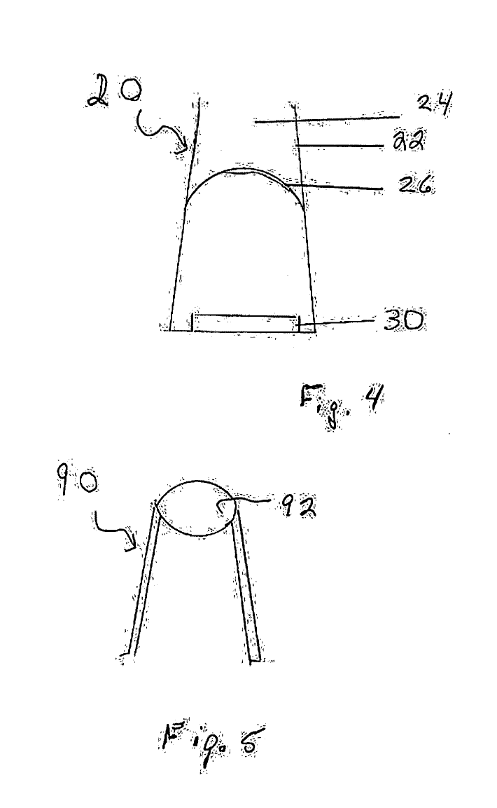

The circuitry 70 is illustrated schematically in FIG. 5, where temperature sensor 30 is in communication with microprocessor 72. The on-off switch 40 is in communication with power source 60, and with microprocessor 72 and display 74. The microprocessor 72 communicates between temperature sensor 30 and audible alarm 50, and once a beam of light has struck the surface of the temperature sensor 30, microprocessor 72 performs the appropriate calculations and determines the temperature of the targeted area, and compares the temperature to information stored in the microprocessor's memory, and if the temperature exceeds the specified threshold value, the microprocessor 72 sends a signal to the display and activates the visual alarm 80 and activates the audible alarm 50. After a specified time has elapsed, if the user has not turned the device 10 off, the microprocessor can turn the audible alarm off. Additional components of the display 74 include a temperature display, a light to illuminate the display, a display of the most recent recorded temperature, or the highest temperature recorded, depending upon how the microprocessor has been programmed.

The circuitry 70 also includes a system to monitor the battery level, and provide the user with a warning when that level has dropped below a specified threshold. The device 10 then emits an audible warning, such as a periodic beep or chirp, to indicate that the battery is running low and should be replaced. The audible warning that the battery is running low is intended to be different from that of the alert mechanism 50, indicating a temperature greater than a specific threshold. The battery 60 can be replaced by means of opening up the battery compartment 62 located on the bottom of the device body 14.

Battery compartment 62 can be of conventional design, and may include either a slide mechanism, a press-fit mechanism, or screw, or other commonly used type of battery compartment, to retain the battery compartment in the closed position. The battery 60 can be any currently available battery, although batteries with extended lifetimes, such as alkaline or lithium batteries, would be preferable. Embodiments could be developed to use and contain rechargeable batteries.

The circuitry 70 can be programmed to vary the time that the audible warning mechanism 50 will sound. This can vary from as little as one second, 5, 10, 20 seconds or longer, or other increments as may be determined by local or national fire or safety codes. It is important that the audible warning mechanism 50 be sufficiently loud and be on for a sufficiently long enough time period that it can be heard and comprehended by the user, who is usually wearing heavy protective clothing. When used by firefighting personnel, the protective clothing should include one or more fire retarding agents, to render the clothing fire resistant. Additionally, a visual warning 80 can be added to the device, such that as the user is handling the device, the alarm can be seen as well as heard.

The controls are designed to be sufficiently large so that they can be used by a person wearing heavy gloves.

The device 10 is sufficiently compact such that it can be carried in a pocket, but can be attached to one or more of the articles of clothing worn by various personnel. Thus, each item of clothing can be manufactured to have a retaining means 102 for this device, generally manufactured from the same material as the clothing article, or a material that is sufficiently flexible to allow for the insertion, retention and removal of the device from the clothing article, but sufficiently durable and/or fire resistant such that it will not compromise the safety of the person wearing it. Thus, in the example of a boot, the retaining means 102 is made of a piece of material similar to that used for either the foot or the upper of the boot, while in the example of a coat, a piece of material comparable to that used for the sleeve. In the example of a fireman's helmet, the retaining means 102 can be formed from the same material as the helmet, or a strip of material that would be used for another type of protective garment, such as the coat, glove or boot, as deemed appropriate by the particular manufacturer. When used on a helmet that has either an attached, a pivotable, or a detachable face shield, the device 10 is placed on the helmet such that when the shield is pivoted upwards, the device 10 does not obstruct the movement of the shield. In other embodiments, the device 10 could be attached to firefighting or rescue equipment, such as a hose nozzle, a ladder, a pole, a stretcher or the like. FIG. 2B shows the device 10 mounted atop the foot portion of a boot, but it is to be understood that the device 10 could also be mounted anywhere else on the boot that is convenient, such as along the outside portion of the boot's upper. Other types of clothing articles to which the heat detector can be mounted include raincoat, vests, shirts, gloves, facemasks, trousers, shorts or a jacket. While firefighting and firemen are referenced in this specification, it is also be to be understood that embodiments of the device and system described herein could be used by others, such as police, civilian and military rescue personnel, and the like.

In use, the sensor 12 is aimed at the desired location, the switch 14 is actuated, the circuitry 70 performs the appropriate calculations, and if the temperature has exceeded a specified value, the audible alert mechanism 50 is activated, and emits an alert.

An additional option is an adjustment means 56 to adjust the volume of the sound emitted by the device 10. The adjustment means can be mounted on a side or top of the device 10. The audible warning can be a siren, a whistle, an alarm bell, alternating high and low pitched siren, buzzer, horn, klaxon horn, air horn or other appropriate warning sound, as known among those skilled in the art.

While body 12 is shown as having a rectangular shape, the body can take any shape (for example only, and not intended as a limitation, oval, circular, square) that can accommodate the components of the present invention.

The device 10 of the present invention can be manufactured from commonly available electronic and mechanical components.

Therefore, although this invention has been described with a certain degree of particularity, it is to be understood that the present disclosure has been made only by way of illustration and that numerous changes in the details of construction and arrangement of parts may be resorted to without departing from the spirit and scope of the invention. While the electronics of the present invention employ conventional electrical circuitry and components, it is to be understood that their replacement using solid state electronics and integrated circuitry, as well as the use of microprocessor technology and sound synthesis, are specifically considered to be contemplated by the present invention.

We claim:

1. A warning system for emergency personnel, the system comprising:
an article of clothing, the article of clothing comprising a means for attaching a heat sensor thereto; and
a heat sensor attached to the article of clothing, the heat sensor comprising:
a housing;
a microprocessor within the housing;
a means for detecting heat, the means for detecting heat being in communication with the microprocessor;
a source of electrical power, the source of electrical power being in communication with the microprocessor; and
a means for warning, the means for warning being in communication with the microprocessor, the means for warning activating a warning that the heat sensed by the heat sensor exceeds a specified temperature.

2. The system as described in claim 1, wherein the means for warning further comprises a means for audibly indicating that the heat sensed by the heat sensor exceeds the specified temperature.

3. The system as described in claim 2, wherein the means for warning further comprises a means for visually indicating that the heat sensed by the heat sensor exceeds the specified temperature.

4. The system as described in claim 2, wherein the heat detector comprises a means for determining whether the temperature exceeds 300 degrees F. (148.9 degrees C.).

5. The system as described in claim 4, wherein the heat detector comprises a means for determining whether the temperature ranges from 300 degrees F. (148.9 degrees C.) to 1000 degrees F. (538 degrees C.).

6. The system as described in claim 2, wherein the means for attaching comprises a loop extending from the article of clothing, and the loop securing the heat sensor therein.

7. The system as described in claim 6, wherein the article of clothing is chosen from the group consisting of a helmet, a coat, a raincoat, a vest, a shirt, an article of footwear, a glove, a facemask, a pair of trousers, a pair of shorts, or a jacket.

8. The system as described in claim 7, wherein the article of clothing further comprises a fire-retardant agent.

9. A method to warn of a heat condition in an area, the method comprising the steps of:
having an article of clothing to which a heat sensor has been attached, approaching an area in which there is a source of heat;
the heat sensor comprising:
a housing;
a microprocessor within the housing;
a means for detecting heat, the means for detecting heat being in communication with the microprocessor;
a source of electrical power, the source of electrical power being in communication with the microprocessor; and
a means for warning, the means for warning being in communication with the microprocessor, the means for warning activating a warning that the heat sensed by the heat sensor exceeds a specified temperature;
directing the heat sensor towards the source of heat;
actuating the heat sensor;
determining whether the source of heat exceeds a specified temperature; and
activating a warning that the heat sensed exceeds the specified temperature.

10. The method as described in claim 9, wherein the means for warning further comprises a means for audibly indicating that the heat sensed by the heat sensor exceeds the specified temperature.

11. The method as described in claim 10, wherein the means for warning further comprises a means for visually indicating that the heat sensed by the heat sensor exceeds the specified temperature.

12. The method as described in claim 10, wherein the heat detector comprises a means for determining whether the temperature exceeds 300 degrees F. (148.9 degrees C.).

13. The method as described in claim 12, wherein the heat detector comprises a means for determining whether the temperature ranges from 300 degrees F. (148.9 degrees C.) to 1000 degrees F. (538 degrees C.).

14. The method as described in claim 10, wherein the means for attaching comprises a loop extending from the article of clothing, and the loop securing the heat sensor therein.

15. The method as described in claim 14, wherein the article of clothing is chosen from the group consisting of a helmet, a coat, a raincoat, a vest, a shirt, an article of footwear, a glove, a facemask, a pair of trousers, a pair of shorts, or a jacket.

16. The method as described in claim 15, wherein the article of clothing further comprises a fire-retardant agent.

17. A method to warn of a heat condition in an area, the method comprising the steps of:
having an article of clothing to which the heat sensor as described in claim 6 has been attached, approaching an area in which there is a source of heat;
directing the heat sensor towards the source of heat;
actuating the heat sensor;
determining whether the source of heat exceeds a specified temperature level; and
activating a warning that the heat sensed exceeds the specified temperature.

18. The method as described in claim 17, wherein the source of heat is chosen from the group consisting of a fire, a smoke condition, a chemical reaction or an electrical source.
